(19) United States
(12) Patent Application Publication
(10) Pub. No.: US 2014/0106940 A1
(43) Pub. Date: Apr. 17, 2014

(54) MOUNTING APPARATUS FOR EXERCISE EQUIPMENT

(71) Applicant: Dare ZIMMERMAN, Burlington (CA)

(72) Inventor: Dare ZIMMERMAN, Burlington (CA)

(21) Appl. No.: 13/802,531

(22) Filed: Mar. 13, 2013

Related U.S. Application Data
(60) Provisional application No. 61/610,118, filed on Mar. 13, 2012.

(51) Int. Cl. F16M 13/02; A63B 69/24

(52) U.S. Cl. CPC F16M 13/027; A63B 69/24
USPC 482/86

(57) ABSTRACT

A heavy bag mounting assembly having a base. A bag supporting member having a partially spherical end is mounted within a bearing member so as to be free to rotate and swivel therein. A bearing support member secures the bearing member to the bag supporting member with the bag supporting member extending through the bearing member. An eye nut is securable to the bearing member for connection of the bearing member to the bag.

### CROSS REFERENCE TO RELATED APPLICATION:

The present application claims the benefit of priority of U.S. Provisional Application No. 61/610,118, filed on Mar. 13, 2012, which is incorporated herein in its entirety.

### FIELD OF INVENTION

The present invention relates to exercise equipment and more particularly to mounting apparatus for mounting a heavy bag.

### BACKGROUND OF THE INVENTION

A problem with prior mounting arrangements for mounting heavy bags is that a significant amount of noise and vibration are transmitted from the bag to a ceiling structure to which the bag is mounted. Accordingly, when one uses a heavy bag mounted with conventional mounting apparatus in a domestic environment, use of the bag will generate an objectionable amount of noise to occupants of the establishment.

It is an object of the present invention to provide a mounting assembly for a heavy bag which transmits less objectionable noise and vibration to a building structure than previously known mounting apparatus.

### SUMMARY OF THE INVENTION

A heavy bag mounting assembly comprising a base having a ceiling face opposite a bag mounting face and a length sufficient to allow mounting between a pair of joists. The base has provision for receiving securing means for rigidly securing the base to the pair of joists. A bag supporting member is provided which has a partially spherical end mounted within a bearing member so as to be free to rotate and swivel therein. A bearing support member is securable to the base to support the bearing and in turn the bag supporting member from the base. The bag supporting member extends through the bearing member. An eye nut is securable to the bearing member for connection of the bearing member to the bag.

### BRIEF DESCRIPTION OF THE DRAWINGS

Preferred embodiments of the present invention are described in detail below with reference to the accompanying illustrations in which:

FIG. 1 is an exploded view of a heavy bag mounting assembly according to the present invention;

FIG. 2 is a bottom plan view of an assembled bag mounting assembly according to the present invention;

FIG. 3 is a section on line 33 of FIG. 2;

FIG. 4 is a bottom plan view of a bag supporting member component of the bag mounting assembly;

FIG. 5 is a section on line 55 of FIG. 4;

FIG. 6 is a front elevation of a snap hook for use with the present invention;

FIG. 7 is an end elevation corresponding to FIG. 6; and,

FIG. 8 is a perspective view corresponding to FIGS. 6 and 7.

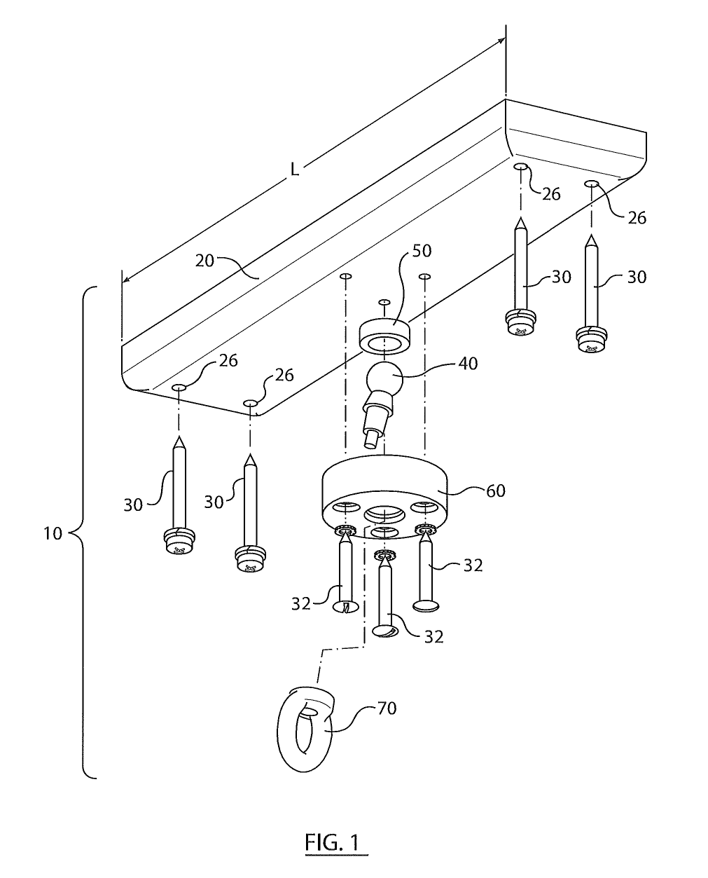

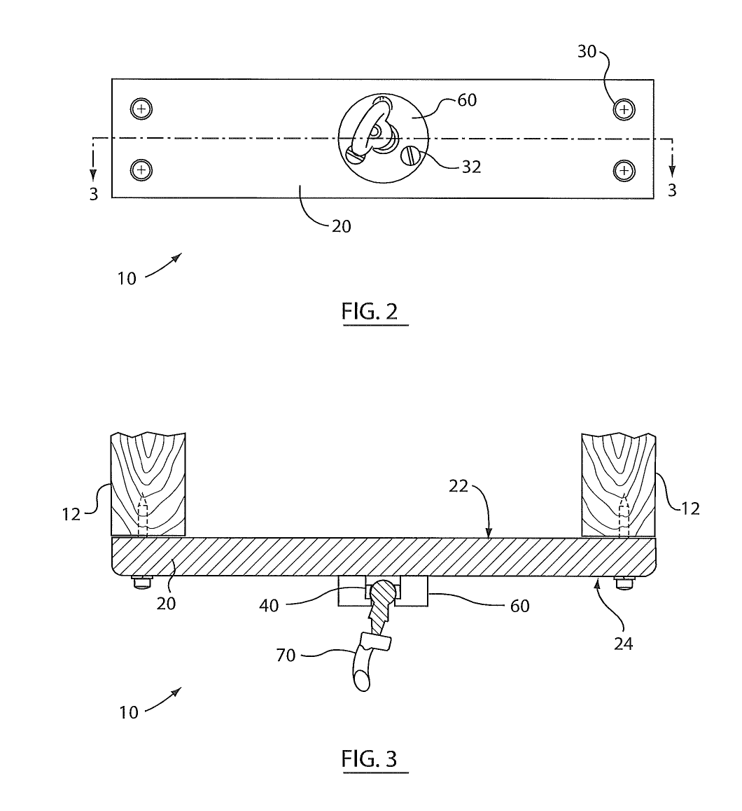

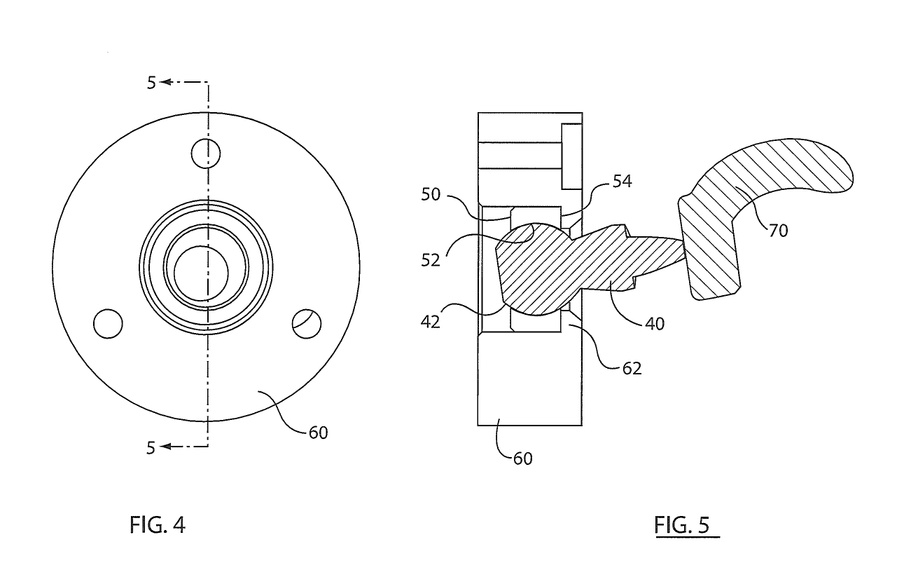

### DESCRIPTION OF PREFERRED EMBODIMENTS

A heavy bag mounting assembly according to the present invention is generally illustrated by reference 10 in the accompanying illustrations. The assembly 10 has a base 20 with a ceiling face 22 opposite a bag mounting face 24 and a length sufficient to allow mounting between a pair of joists 12.

The base 20 has provision such as holes 26 for receiving securing means such as screws 30 for securing the base 20 to the pair of joists 12.

A bag supporting member 40 having a partially spherical end 42 is mounted within a bearing member 50 so as to be free to rotate and swivel within the bearing member 50. This can best be seen in FIG. 5. The bearing member 50 has a curved face 52 which registers with the spherically shaped end 42.

A bearing support member 60 is securable to the base such as by means of screws 32 to support the bearing member 50 and in turn the bag supporting member 40 from the base 20 as can be seen in FIG. 5, the bearing support member 60 has a flange 62 on which a lower face 54 of the bearing member 40 rests.

The bag supporting member 40 extends through the bearing member away from the base 20. An eye nut 70 is securable to the bearing member 50 for connection of the bearing member to the heavy bag (not shown).

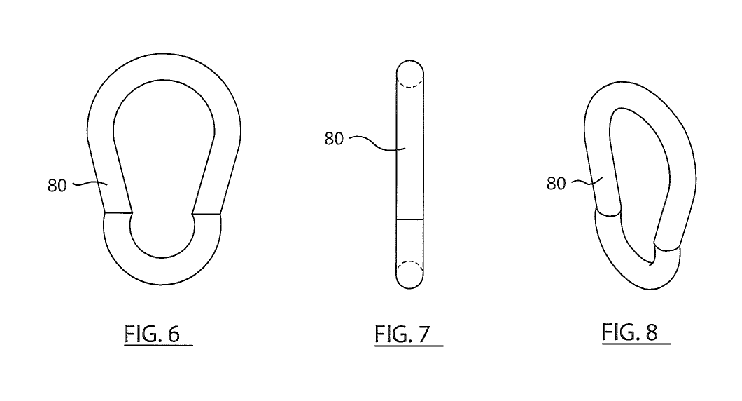

A heavy bag would be connected to the eye nut with a snap hook as is known in the art. A smaller snap hook is preferred over a larger one as excessive clearance associated with a large snap hook may cause an increase in vibration. A suitable snap hook 80 is illustrated in FIGS. 6 through 8.

The above description is intended in an illustrative rather than a restrictive sense. Variations to the preferred embodiments described may be apparent to persons skilled in the art without departing from the spirit or scope of the invention as defined by the claims set out below.

What is claimed is:

1. Heavy bag mounting assembly comprising:
a support base having a ceiling face (22) opposite a bag mounting face (24) and a length sufficient to allow mounting between a pair of joists (12);
said base having provision (26) for receiving, securing means (30) for rigidly securing said base to said pair of joists;
a bag supporting member (4) having a partially spherical end (42) mounted within a bearing member (50) so as to be free to rotate and swivel therein;
a bearing support member (60) securable to said base to support said bearing member and in turn said bag supporting member from said bases;
said bag supporting member extending through said bearing member away from the base; and,
an eye nut (70) securable to said bearing member for connection of said bearing member to said bag.

2. A heavy bag mounting assembly as generally described and illustrated herein.
